(19) United States
(12) Patent Application Publication
(10) Pub. No.: US 2004/0191161 A1
(43) Pub. Date: Sep. 30, 2004

(54) Compounds of lithium nickel cobalt metal oxide and the methods of their fabrication

(76) Inventors: Chuanfu Wang, Shenzhen (CN); Zhanfeng Jiang, Shenzhen (CN); Huiquan Liu, Shenzhen (CN); Junqing Dong, Shenzhen (CN)

Correspondence Address: EMIL CHANG, LAW OFFICES OF EMIL CHANG, 874 JASMINE DRIVE, SUNNYDALE, CA, 94086, US

(21) Appl. No.: 10/823,931

(22) Filed: Apr. 14, 2004

(30) Foreign Application Priority Data
Aug. 15, 2003 (CN) 03140216.X
Apr. 14, 2003 (CN) 03114242.7
Nov. 19, 2002 (CN) 02151991.9
Aug. 15, 2003 (CN) 03140196.1
May 9, 2003 (CN) 03126555.3
Jun. 23, 2003 (CN) 03139607.0
Dec. 10, 2002 (CN) 02156241.5
Oct. 28, 2003 (CN) 0310111966.4

(51) Int. Cl. H01M 4/58

(52) U.S. Cl. 423/594.2; 423/594.4

(57) ABSTRACT

This invention discloses compounds of lithium nickel cobalt metal oxide and the methods of their fabrication. The formula for said compounds of lithium nickel metal of oxide is LiₐNi_{1-b-c}Co_{b}M_{c}O₂ where 0.97≦a≦1.05 , 0.01≦b≦0.30 , 0≦c≦0.10, and M is one or more or the following: manganese, aluminum, titanium, chromium, magnesium, calcium, vanadium, iron, and zirconium.

The method for the fabrication of said compounds of lithium nickel cobalt metal oxide includes: (a) fabricating a cobalt nickel hydroxy compound; (b) ballgrinding to evenly mix said cobalt nickel hydroxy compound; a lithium compound and compound of said metal M; (c) calcining said mixture in oxygen at between 600° C. and 720° C. for 1 hour to 10 hours; (d) calcining a second time in oxygen at between 750° C. and 900° C. for 8 hours to 10 hours; (e) cooling the twice calcined compound rapidly; (f) ballgrinding and then sifting the cooled compound to obtain said compound of lithium nickel cobalt metal oxide.

The fabrication method of this invention produces said compound containing a high percentage of secondary granules that are formed by the aggregation of crystalline granules. These granules are spherically or elliptically shaped with no halite magnetic domains resulting in a material that has excellent electrochemical properties. Using these materials in the positive electrodes of rechargeable batteries produce batteries with high capacity and good cycle characteristics.

### CROSS REFERENCE

This application claims priority from the following Chinese patent applications:

“Compounds of Lithium Nickel Cobalt Metal Oxides and Their Methods of Fabrication” filed on Apr. 14, 2003, having a Chinese Application No. 03114242.7;

“Active Materials for the Positive Electrodes of Anhydrous Rechargeable Batteries, Their Methods of Fabrication and Anhydrous Rechargeable Batteries Using said Materials”, filed on Aug. 15, 2003, and having a Chinese Application No. 03140216.x.;

“Methods for Preparation from Carbonate Precursors the Compounds of Lithium Transition Metals Oxide” filed on Nov. 19, 2002, having a Chinese Application No. 02151991.9;

“A Type of Lithium Ion Rechargeable Battery and Methods of Fabrication for Its Positive Electrodes”, filed on Aug. 15, 2003 and having a Chinese Application No. 03140196.1; and

“Materials for the Positive Electrodes of Anhydrous Rechargeable Batteries and Their Methods of Fabrication”, filed on May 9, 2003 and having a Chinese Application No. 03126555.3.

“Stacked Lithium Secondary Battery”, filed on Jun. 23, 2003 and having a Chinese Application No. 03139607.0.

“Lithium Ion Rechargeable Battery”, filed on Dec. 10, 2002 and having a Chinese Application No. 02156241.5.

“Lithium Ion Rechargeable Battery”, filed on Oct. 28, 2003 and having a Chinese Application No. 0310111966.4.

All of the above applications are incorporated herein by reference.

This application is a continuation-in-part of a U.S. patent application entitled: “Methods for Preparation from Carbonate Precursors the Compounds of Lithium Transition Metal Oxide”, filed on Nov. 19, 2003 having a U.S. patent application Ser. No. 10/717,236. This application is also a continuation-in-part of a U.S. patent application entitled: “Lithium Ion Secondary Batteries”, filed on Dec. 10, 2003 and having a U.S. patent application Ser. No. 10/733,018.

### FIELD OF INVENTION

This invention relates to compounds of lithium nickel cobalt metal oxide and their methods of fabrication. Particularly, it relates to compounds of lithium nickel cobalt metal oxide and their use as the active materials for the positive electrodes of anhydrous rechargeable batteries.

### BACKGROUND

In recent years, with the widespread use of a variety of portable electronic products, lithium ion rechargeable batteries with its many superior characteristics such as high voltage, large specific capacity, low self-discharge, and zero memory effects, have been highly favored. The positive material used in lithium batteries is mainly embedded-type compounds. At present, the material for the positive electrode with the best overall properties is the lithium oxide, LiCoO₂.

However, the LiCoO₂ is expensive and its source scarce. Therefore, compounds of lithium manganese oxides and compounds of lithium nickel oxides have been suggested as substitutes. The compounds of lithium manganese oxides have the disadvantages that batteries with these compounds as positive electrodes have lower theoretical capacities and larger decreases in their capacities during repeated charging and discharging cycles and under higher temperatures.

On the other hand, even though the compounds of lithium nickel oxides do not possess the same disadvantages as the compounds of lithium manganese oxides, LiNiO₂ possesses the same crystal structure as LiCoO₂ and its properties are worse. Ni3+ ion, when compared with the Co3+ ion, more easily reverts back to the Ni2+ ion. Since the size of the Ni2+ ion and the Li+ ion are similar, (rNi2+=8.7 nm, rLi+=9.0 nm), the Ni2+ion and the Li+ ion can easily substitute each other, forming the halite magnetic domains that have inactive electrochemical properties and resulting in the lowering of the capacities of batteries with these compounds as positive electrodes. Calcining a mixture of compounds of lithium, nickel, and cobalt has generally been used to prepare the LiNi_{(1y)}CO_{y}O₂ material.

The article in Chem Express, 6, 161, 1991 provides a method to fabricate a type of LiNi_{1-y}CO_{y}O₂ material by mixing Ni(NO₃)₂, Co(NO₃)₂ and LiOH solution; drying this mixture at 90° C.; and, heat treating it at 800° C. in air to produce the final product.

Japan Patent Publications 2000-058053 discloses the composition method for a type of LiN_{1-b}Co_{b}O₂ material. This method includes: calcining a predetermined ratio of a mixture of lithium, cobalt, and nickel salts in dry atmosphere without carbon dioxide at 300° C. to 700° C. for over 2 hours, grinding, then calcining again at 700° C. to 900° C. to obtain the desired material.

Since, the Ni3+ ion easily reverts back into the Ni2+ ion at high temperature, its is customary to first oxidize the Ni2+ ion to become the Ni3+ ion, then calcining to react the mixture at lower temperatures to fabricate the LiNi_{(1-b)}Co_{b}O₂ material.

Chinese Patent Publications CN1142691 provides a method of heat treating oxides containing cobalt, hydroxide compounds of nickel, Ni_{1-y}Co_{y}OOH, and a lithium compound at 400° C. to 500° C. to fabricate the LiNi_{1-y}Co_{y}O₂ material.

The above-described methods for the fabrication of the LiNi_{1-y}Co_{y}O₂ material all have the disadvantage of producing a material with insufficient crystallization and non-uniform crystalline structure. There materials, when used as positive electrodes in batteries, produce batteries having a small specific surface area resulting in poor electrochemical properties.

Due to the limitations of the prior art, it is therefore desirable to have novel fabrication methods for novel materials that have good electrochemical properties such that when these novel materials are used as materials for positive electrodes of batteries, the batteries have high capacities and good cycle characteristics.

### SUMMARY OF INVENTION

An object of this invention is to disclose fabrication methods for compounds of lithium nickel cobalt metal oxides and said compounds of lithium nickel cobalt metal oxides having a high degree of crystallization with complete crystalline shapes and good electrochemical properties.

Another object of this invention is to disclose said compounds of lithium nickel cobalt metal oxide, which when used as the active materials for the positive electrodes of batteries produce batteries with good discharge, cycle, and large current discharge characteristics.

The present invention discloses compounds of lithium nickel cobalt metal oxide and their methods of fabrication. In the preferred embodiment, a formula for said compounds of lithium nickel metal of oxide is LiₐNi_{1-b-c}Co_{b}M_{c}O₂ where 0.97≦a≦1.05 , 0.01≦b≦0.30 , 0≦c≦0.10, and M is one or more of the following: manganese, aluminum, titanium, chromium, magnesium, calcium, vanadium, iron, and zirconium.

Said method for the fabrication of said compounds of lithium nickel cobalt metal oxide includes: (a) fabricating a cobalt nickel hydroxy compound; (b) ballgrinding to evenly mix said cobalt nickel hydroxy compound; a lithium compound and compound of said metal M; (c) calcining said mixture in oxygen at between 600° C. and 720° C. for 1 hour to 10 hours; (d) calcining a second time in oxygen at between 750° C. and 900° C. for 8 hours to 10 hours; (e) cooling the twice calcined compound rapidly; and (f) ballgrinding and then sifting the cooled compound to obtain said compound of lithium nickel cobalt metal oxide.

An advantage of this invention is that the compound of lithium nickel cobalt metal oxides of this invention, LiₐNi_{1-b-c}CO_{b}M_{c}O₂, and, fabricated by the methods of this invention exhibit excellent electrochemical properties with no formation of halite magnetic domains. By the choice of appropriate initial ingredients and specifications for the formation of secondary granules and crystalline granules, this invention produces a material with high tap density. Batteries using said compounds as the active ingredients for the their positive electrodes exhibit only small decreases in electrical capacity and discharge voltage after repeated charges and discharge.

### DESCRIPTION OF DRAWINGS

The foregoing and other objects, aspects and advantages of the invention will be better understood from the following detailed description of preferred embodiments of this invention when taken in conjunction with the accompanying drawings in which:

FIG. 1 is a scanning electron micrograph of an embodiment of the cobalt nickel hydroxy compound magnified 200 times.

FIG. 2 is a scanning electron micrograph of an embodiment of the compound of lithium nickel cobalt metal oxide magnified 2000 times.

FIG. 3 is a scanning electron micrograph of an embodiment of the compound of lithium nickel cobalt metal oxide magnified 10000 times.

FIG. 4 is a diagram of the cross section of an embodiment in the form of a button cell battery,

### DETAILED DESCRIPTION OF THE PREFERRED EMBODIMENTS

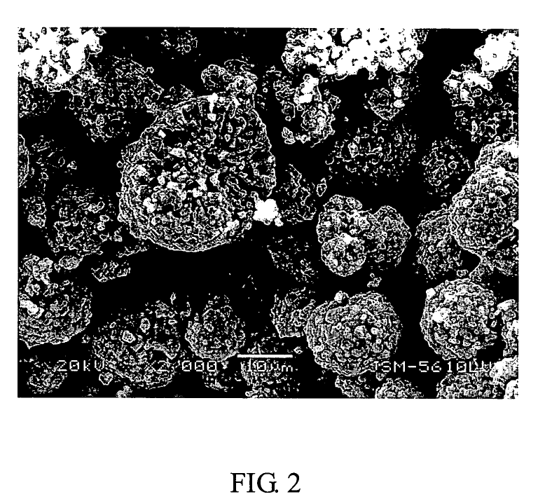

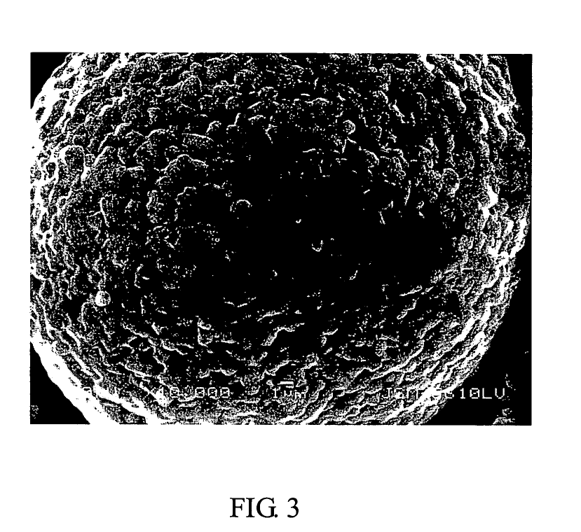

This invention relates to compounds of lithium nickel cobalt metal oxide and their methods of fabrication. The chemical formula for said compound is LiₐNi_{1-b-c}CO_{b}M_{c}O₂ where 0.97≦a≦1.05 , 0.01≦b≦0.30 , 0≦c≦0.10, and M is one or more or the following: manganese, aluminum, titanium, chromium, magnesium, calcium, vanadium, iron, and zirconium. The scanning electron micrographs of an embodiment of said compound is shown in FIGS. 2 and 3.

One of the characteristics of embodiments of this invention is that in the X-ray diffraction picture (CuKα) of the compounds of lithium nickel cobalt metal oxide of these embodiments, the ratio of the intensity of the peak on the said compound's (003) crystalline surface, and the intensity of its peak on said compound's (104) crystalline surface, I₀₀₃/I₁₀₄ is larger than 1.20.

Another characteristic of the embodiments of the compounds of lithium nickel cobalt metal oxide is that said compounds are constituted of crystalline granules, i.e., primary granules, and secondary granules formed by the aggregation or combination of the primary granules, i.e., crystalline granules. The secondary granules are formed during calcinations by the aggregation of the crystalline granules. The granule diameter of said crystalline granules is between 0.5 μm and 4 μm while the granule diameter of the secondary granules is between 10 μm and 40 μm. Also, the volume of the crystalline granules is<10% of the total volume of the compound. It is preferred that the shape of the secondary granules be either spherical or elliptical shaped.

The formation of halite magnetic domains with inactive electrochemical properties is another concern in the fabrication of said compounds of lithium nickel cobalt metal oxides. In order to prevent the formation of these halite magnetic domains, metals, such as cobalt, manganese, or iron etc. can be used to partially replace nickel. The compounds of lithium nickel cobalt oxide, LiNi_{1-y}Co_{y}O_{2,}, using cobalt as the replacement metal exhibits better overall properties.

The X-ray diffraction picture (CuKα) of the compounds of lithium nickel cobalt metal oxides can be used to determine whether there is halite magnetic domain formation. In general, when the ratio of intensity of a compound's diffraction peak on its (003) crystalline surface, and the intensity of its diffraction peak on its (104) crystalline surface, I₀₀₃/I₁₀₄ is>than 1.20, then the compound of lithium nickel cobalt metal oxide fundamentally does not have halite magnetic domain formation.

The value of “b” in the chemical formula of the compounds of lithium nickel cobalt metal oxide is selected to be less than or equal to 0.3 in order to limit the cobalt content in said compound. Said compound, when used as the material for the positive electrode of batteries, would produce batteries having lower electrical specific capacity if the cobalt content in said compound is too high.

In preferred embodiments, the average granule diameter of the secondary granules of the compounds of lithium nickel cobalt metal oxide is limited to between 10 μm and 40 μm. If the granule diameter of the secondary granules is too small, when said compounds of lithium nickel cobalt metal oxide is used as the material of positive electrodes, a portion of the granules cannot be in contact with the conducting agent such that additional conducting agent must be used in order to obtain the desired conduction rate. On the other hand, if the average granule diameter of the secondary granules is over 40 μm, the electrolyte in batteries cannot penetrate the inside of said secondary granules such that only part of the granules can be utilized during the charging and discharging actions.

Limiting the secondary granules of said embodiments to be spherical or elliptical shaped would produce compounds with sufficient tap density. Moreover, said compounds with secondary granules of uneven shapes would produce batteries with unfavorable large current discharge characteristics when they are used as material for the positive electrodes of batteries.

An embodiment of the method of fabrication for the compounds of lithium nickel cobalt metal oxide includes first fabricating first the cobalt nickel hydroxy compound and then using said compound to fabricate the compounds of lithium nickel cobalt metal oxide.

Said cobalt nickel hydroxy compound is fabricated by adding ammonia to a uniformly mixed solution of cobalt sulfate and nickel sulfate to form the cobalt nickel hydroxy compound, Ni_{1-b}Co_{b}(OH)₂.

The fabrication of the compound of lithium nickel cobalt metal oxide from the cobalt nickel hydroxy compound includes the following steps:

(a) Ballgrinding to mix evenly predetermined quantities calculated from the chemical formulae the following: lithium compound, said Ni_{1-y}Co_{y}(OH)₂, and M compound;

(b) Calcining in a first calcination said mixture in oxygen atmosphere at between 600° C. and 720° C. for 1 hour to 10 hours;

(c) Calcining in a second calcination in oxygen atmosphere at 750° C. to 900° C. for 8 hours to 20 hours;

(d) Cooling rapidly the twice calcined product from step such that the high temperature phase of the twice calcined product is retained;

(e) Ballgrinding the cooled mixture; and

(f) Sifting the ballgrinded mixture to obtain the compound of lithium nickel cobalt metal oxide compound with the chemical formula LiₐNi_{1-b-c}Co_{b}M_{c}O₂.

In order to fabricate said compounds of lithium nickel cobalt metal oxide where the metal ions are distributed evenly and reduce the redistribution during the combination reaction of nickel and cobalt, embodiments use said cobalt nickel hydroxy compound, Ni_{1-b}Co_{b}(OH)₂, fabricated by adding ammonia to a uniformly mixed solution of cobalt sulfate and nickel sulfate.

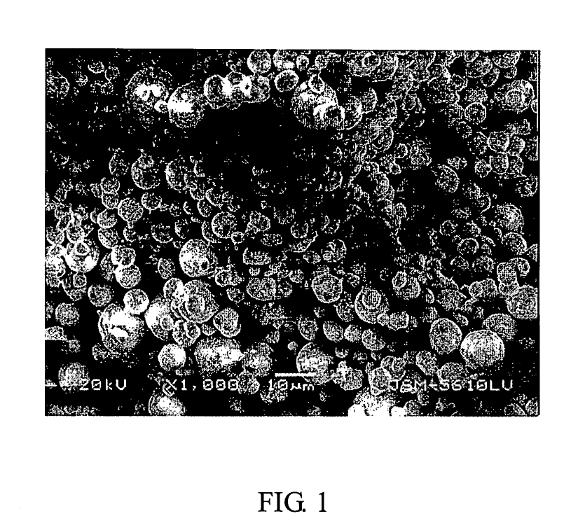

It is preferable to control the shape of the cobalt nickel hydroxy compound Ni_{1-b}Co_{b}(OH)₂ to be either spherical or elliptical shaped with average granule diameters D₅₀≧8 μm, D₁₀≧4 μm, and D₉₀≦30 μm. The shape of the cobalt nickel hydroxy compound can be examined with a scanning electron microscope while the granule diameters D₅₀, D₁₀, and D₉₀.can measured using the laser-scatter particle analyzer. Said cobalt nickel hydroxy compound can be fabricated to be spherically or elliptically shaped as shown in FIG. 1. The process of fabricating the LiₐNi_{1-b-c}Co_{b}M_{c}O₂ compounds does not destroy the spherical or elliptical shapes and instead grows many crystallites as shown in FIG. 2. Spherically or elliptically shaped crystalline granules and secondary granules of embodiments of this invention can be obtained from the cobalt nickel hydroxy compound. Thus, controlling the shape and granule diameter of the compounds of lithium nickel cobalt metal oxide can be accomplished by controlling the shape and granule diameter of the cobalt nickel hydroxy compounds.

An embodiment of a fabrication method to control the above stated preferred conditions for the cobalt nickel hydroxy compound is to specify that the concentration of said nickel sulfate to be between 1.5 mole/liter and 2 mole/liter; the concentration of said cobalt sulfate to be between 0.3 mole/liter and 0.5 mole/liter, the concentration of said ammonia to be between 10 mole/liter and 14 mole/liter and that the reaction between the above stated chemical occur for 9 hours to 12 hours in a solution with pH between 11 and 12 and at a temperature of between 40° C. and 60° C.

In order to fabricate said compounds of lithium nickel cobalt metal oxide where the metal ions are distributed evenly and reduce the redistribution during the combination reaction of nickel and cobalt, the embodiments use said cobalt nickel hydroxy compound, Ni_{1-b}Co_{b}(OH)₂, fabricated by adding ammonia to a uniformly mixed solution of cobalt sulfate and nickel sulfate.

In order to compensate for the vaporization during the high temperature calcination process, a preferred specification is to add additional amounts of lithium compound when fabricating said compounds of lithium nickel cobalt metal oxide from the cobalt nickel hydroxy compound. In formulating the amounts of the ingredients needed, the ratio of the molar volume of lithium with the ratio of the sum of the molar volume of nickel, cobalt and said metal M, i.e., the molar volume of Li/(Ni+Co+M), should be between 1.01 and 1.10.

Another preferred specification for the embodiments is for the oxygen atmosphere during the first and second calcinations to be approximately 1 atmosphere, i.e., between 0.08 MPa and 0.1 MPa.

The lithium compound used in the reaction can be compounds such as lithium hydroxide, lithium oxide, lithium peroxy-oxide, lithium carbonate, and lithium nitrate. Customarily, lithium carbonate is used when cost is taken into consideration.

In fabricating the embodiments, cobalt nickel hydroxy compound, the lithium and compounds of M are mixed together evenly and then calcined twice under high temperatures. The first calcination is at 600° C. to 720° C. for 1 hour to 10 hours to decompose the cobalt nickel hydroxy compound and to oxidize the Ni2+ ion. The second calcination is at 750° C. to 900° C. for 8 hours to 20 hours for the formation of the crystalline granules and secondary granules. The lithium ions from the decomposed lithium compound enter the inside of the cobalt nickel hydroxy compound sphere to form many LiₐNi_{1-b-c}Co_{b}M_{c}O₂ crystalline granules, i.e., primary granules whose average granule diameter is between 0.5 μm and 4 μm. These crystalline granules uses the cobalt nickel hydroxy compound as the center and combine with each other to continuously grow in size to form the secondary granules of LiₐNi_{1-b-c}Co_{b}M_{c}O₂ whose average granule diameter is between 10μm and 40 μm, as illustrated in FIG. 3. If the temperature in the second calcination is lower than 750° C. or the calcination time is less than 8 hours, then the growth of the crystalline granules cannot be completed. If the temperature of the calcination is greater the 900° C. or the time of calcination is longer than 20 hours, then the crystallites have grown too big such that they extrude and cannot aggregate and combine to form secondary granules. In using said embodiments as material for the positive electrodes of batteries, it is preferable to have as many secondary granules and as few crystalline granules as possible. In practice, a volume of the crystalline granules that is less than or equal to 10% of the total volume of the material can be obtained. When American Honeywell Microtarc X100 testing equipment is used to determine the distribution of granule diameters in the embodiments, the results are that when D₁₀≧6 μm, embodiments of this invention do not contain more than 10% by volume crystalline granules that have not been formed into secondary granules.

Since Ni3+ ion reverts back to Ni2+ ion at temperatures higher than 600° C., therefore, oxygen atmosphere is needed to control the progress of this reaction. Experiments show that it is preferable for the calcination process to in oxygen pressure of approximately 1 atmosphere, i.e., between 0.08 MPa and 0.1 MPa.

In order to compensate for the volatilization of lithium during high temperature calcination, additional amounts of lithium compound have to be added in the formulation of the initial ingredients for fabricating embodiments. However, since the calcination to fabricate said the compounds of lithium nickel cobalt metal oxide cannot occur at overly high temperatures or for overly long time periods, excessive quantities of initial lithium compound can lead to the existence of contamination in the final product. Therefore in formulating the quantity of initial ingredients, it is preferable that the molar ratio of Li/Li+Co+M) be between 1.01 and 1.10.

LiₐNi_{1-b-c}Co_{b}M_{c}O₂ has different structures at high and low temperatures. Moreover, only the hexagonal layered halite structure at high temperature has good electrochemical properties. Therefore, rapid cooling such as cooling the heated calcined product at room temperature in a dry atmosphere can be used to retain the high temperature phase structure of the compound of lithium nickel cobalt metal oxide.

The specified temperature for the calcination process is above the melting point for commonly used lithium compounds such as lithium hydroxide, lithium carbonate, and lithium nitrate. Therefore the lithium compound is in melted form during calcination. In order to avoid the existence of domains with missing lithium and domains rich with lithium, the thickness of the material being calcined should not be over 5 centimeters.

In order to illustrate the physical and electrochemical properties of the embodiments of said compounds of lithium nickel cobalt metal oxide and the effect of different embodiments of fabrication methods, the following specific embodiments and comparison examples are discussed below.

### Effects of Fabrication Conditions on Compounds of Lithium Nickel Cobalt Metal Oxide (Embodiments 1 through 6 and Comparison Examples 1 through 5)

Cobalt nickel hydroxy compound, Ni_{0.81}Co_{0.19}(OH)₂, is used to fabricate the Embodiments and Comparison examples by ballgrinding to mix said cobalt nickel hydroxy compound that are elliptical or spherical in shape with granule diameter between 8 μm and 10 μm with 5.2 times the molar equivalent of lithium carbonate. Table 1 shows the different calcinations conditions for Embodiments Comparison Examples, the physical properties of the compounds produced, and the electrical properties of batteries when the compounds fabricated was used as material for positive electrodes of batteries.

The following procedures and equipment are used to measure, test, and compare the properties of the Embodiments and Comparison Examples.

Powdered X-ray diffraction (Cu-Kα) is used to determine the structure of the Embodiments and Comparison Examples and to test whether there is lithium carbonate contamination.

After the Embodiments and Comparison Examples are sifted with a 400 mesh with a gauge of 38.5 μm, JEOL's scanning electron microscope JSM-5610 tester is used to determine the shape and size of the secondary granules and the crystalline granules that are formed at 2000 magnification and 10000 magnification.

American Honeywell Microtarc X-1000 analyzer, a granule diameter distribution analyzer, is used to determine the value of D₅₀, D₉₀, and D₁₀ of the Embodiments and Comparison Examples.

100 g of the product is placed in a slender long cylinder marked with even calibrations. The cylinder is dropped to freefall from a height of 50 cm onto a rubber floor for 100 times. The volume of the product is then read to calculate the tap density.

To fabricate the material for the positive electrodes from each said Embodiments and Comparison Examples, polyvinylidene fluorine (PVDF) is dissolved in N-methyl-pyrrolidone (NMP) at 120° C.; fully mix said dried Embodiments or Comparison Examples, acetyline black (conducting agent), and the dissolved PVDF in the weight ratio of 85:10:5; and Dry for over four hours to obtain the material for the positive electrode material.

To fabricate a positive electrode for a rechargeable battery, 0.102 g of the mixture of the material is used for the positive electrode and a nickel net with small pores that has been treated with hydrochloric acid and dried as the current collector to form a disc with φ 13 mm diameter at 10 Mpa pressure; and place the disc in a vacuum furnace at 160° C. for 4 hours to disperse binder agent and form the positive electrode slice of the battery.

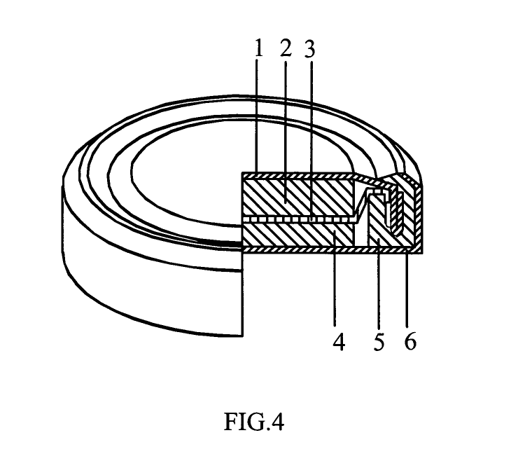

To make button cell battery (FIG. 4) using the positive electrode made with material from Embodiment and Comparison Examples, in a glove box in Ar atmosphere, use the positive electrode slice 4, a lithium slice with surface oxide material and φ 16 mm diameter as the negative electrode 2, a polyethylene multiple aperture membrane as the separator membrane 3, a positive electrode shell 6, a negative electrode shell 1, and an insulation gasket 5. The battery uses 1 mol./liter of lithium phosphate hexaflouride (LiPF₆) as the electrolyte agent, and, ethylene carbonate (Ec) and dimethyl carbonate (DMC) mixed in a predetermined weight ratio as the electrolyte solution.

The battery can be tested 1 hour after fabrication. To find the initial specific discharge capacity, the battery is charged with 1 mA of current until the open circuit voltage reaches 4.2 v. After setting aside for 30 minutes, it is discharged at 1 mA until the open circuit voltage is 3.0 volts. The resulting discharge capacity is the initial discharge capacity. The initial specific discharge capacity is the (initial discharge capacity)/the weight of the positive material. Its unit is in mAh/g.

To test the battery's cycle characteristics, the above described charging and discharging specifications to repeatedly charge and discharge battery for 100 times is followed. The 100 cycle capacity retention rate can be obtained by the following:

100 cycle capacity retention rate=(discharge capacity at the 100^{th} discharge)/(initial discharge capacity)*100%.

To test for the large current discharge characteristics, a new battery that has never been charged or discharged is charged with 1 mA of current until the open circuit voltage reaches 4.2 v; set aside for 30 minutes then discharge battery with 1 mA of current until the open circuit voltage reaches 3.0 v to obtain the discharge capacity defined as 1 mA discharge capacity; then charge battery with 1 mA of current until the open circuit voltage reaches 4.2 v; set aside for 30 minutes; then discharge battery with 5 mA of current until open circuit voltage reaches 3.0 v. The resulting discharge capacity is defined as the 5 mA discharge capacity. The large current discharge characteristics can be obtained by the following:

Large current discharge characteristics=(5 mA discharge capacity)/(1 mA discharge capacity).

Table 1 shows the test results of the above procedures.

| | | | | | | Primary | Gra-nule | |
|---|---|---|---|---|---|---|---|---|
| | First | Second | | | Secondary | (Crystalline) | Diameter | |
| Table 1 | Calcination | Calcination | | Lithium | Granules | Granules | Distribution | Tap |
| Embodiment | Temperature | Temperature | Calcination | Carbonate | Shape/Size | Shape/Size | D₅₀/D₁₀ | Density |
| Number | (° C.)/(h) | (° C.)/(h) | Atmosphere | Mixed In | (μm) | (μm) | (μm) | (g/cm3) |
| Embodiment | 600/8 | 750/20 | Oxygen | No | Spherical/ | Spherical/ | 11.8/6.8 | 2.45 |
| 1 | | | | | 11.5 | 2.0 | | |
| Embodiment | 650/6 | 750/20 | Oxygen | No | Spherical/ | Spherical/ | 11.7/6.6 | 2.43 |
| 2 | | | | | 11.5 | 2.0 | | |
| Embodiment | 700/1 | 800/16 | Oxygen | No | Spherical/ | Spherical/ | 12.0/6.6 | 2.52 |
| 3 | | | | | 12.0 | 2.5 | | |
| Embodiment | 650/6 | 800/16 | Oxygen | No | Spherical/ | Spherical/ | 12.2/6.9 | 2.51 |
| 4 | | | | | 12.0 | 2.5 | | |
| Embodiment | 650/6 | 850/12 | Oxygen | No | Spherical/ | Spherical/ | 12.9/6.5 | 2.48 |
| 5 | | | | | 13.0 | 3.0 | | |
| Embodiment | 650/6 | 900/8 | Oxygen | No | Spherical/ | Spherical/ | 14.4/6.8 | 2.44 |
| 6 | | | | | 14.0 | 3.5 | | |
| Comparison | 500/10 | 800/16 | Oxygen | No | Uneven/ | Uneven/ | 13.3/7.0 | 2.10 |
| Example 1 | | | | | 13.0 | 3.0 | | |
| Comparison | 750/1 | 800/16 | Oxygen | No | Uneven/ | Uneven/ | 11.6/6.2 | 2.18 |
| Example 2 | | | | | 11.0 | 2.0 | | |
| Comparison | 650/6 | 700/30 | Oxygen | Yes | Spherical/ | Spherical/ | 9.8/4.4 | 2.48 |
| Example 3 | | | | | 10.0 | 0.2 | | |
| Comparison | 650/6 | 1000/4 | Oxygen | No | No | Spherical/ | 5.2/2.8 | 1.89 |
| Example 4 | | | | | | 5.5 | | |
| Comparison | 650/6 | 800/16 | Air | Yes | Spherical | Uneven/ | 10.4/5.5 | 2.03 |
| Example 5 | | | | | with Burrs/ | 0.5 | | |
| | | | | | 10.0 | | | |

| | | | | Initial | | Large |
|---|---|---|---|---|---|---|
| (C'td) | First | Second | | Discharge | 100 Cycle | current |
| Table 1 | Calcination | Calcination | | Specific | Capacity | Discharge |
| Embodiment | Temperature | Temperature | Calcination | Capacity | Retention | Characteristics |
| Number | (° C.)/(h) | (° C.)/(h) | Atmosphere | (mAh/g) | Rate (%) | (%) |
| Embo- | 600/8 | 750/20 | Oxygen | 178 | 92.7 | 78.4 |
| Diment 1 | | | | | | |
| Embo- | 650/6 | 750/20 | Oxygen | 180 | 92.4 | 77.9 |
| Diment 2 | | | | | | |
| Embo- | 700/1 | 800/16 | Oxygen | 181 | 92.0 | 78.7 |
| Diment 3 | | | | | | |
| Embo- | 650/6 | 800/16 | Oxygen | 185 | 92.8 | 78.6 |
| Diment 4 | | | | | | |
| Embo- | 650/6 | 850/12 | Oxygen | 183 | 91.9 | 78.2 |
| Diment 5 | | | | | | |
| Embo- | 650/6 | 900/8 | Oxygen | 184 | 92.4 | 76.2 |
| Diment 6 | | | | | | |
| Comparison | 500/10 | 800/16 | Oxygen | 176 | 85.4 | 50.3 |
| Example | | | | | | |
| 1 | | | | | | |
| Comparison | 750/1 | 800/16 | Oxygen | 178 | 83.2 | 54.9 |
| Example | | | | | | |
| 2 | | | | | | |
| Comparison | 650/6 | 700/30 | Oxygen | 156 | 71.9 | 56.7 |
| Example | | | | | | |
| 3 | | | | | | |
| Comparison | 650/6 | 1000/4 | Oxygen | 182 | 86.4 | 45.1 |
| Example | | | | | | |
| 4 | | | | | | |
| Comparison | 650/6 | 800/16 | Air | 160 | 77.0 | 60.4 |
| Example | | | | | | |
| 5 | | | | | | |

### Effects of Cobalt Content (Embodiments 7 through 11 and Comparison Examples 6 through 9)

Table 2 shows battery characteristics for different values of b for the in Ni_{1-b}Co_{b}(OH)₂. All other specifications and conditions are as the same as Embodiment 4 for Embodiment 7 through 12 and Comparison Examples 6 through 9. Properties such as shape, granule diameter and tap density are basically the same as Embodiment 4. Other test results are shown in Table 2.

| | | Initial | | Large |
|---|---|---|---|---|
| | | Discharge | 100 Cycle | current |
| Table 2 | | Specific | Capacity | Discharge |
| Embodiment | Level of b Ni₁₋ | Capacity | Retention | Charac- |
| Number | _{y}Co_{y}(OH)₂ | (mAh/g) | Rate (%) | teristics (%) |
| Embodiment 7 | 0.01 | 192 | 85.5 | 64.5 |
| Embodiment 8 | 0.05 | 190 | 87.8 | 73.3 |
| Embodiment 9 | 0.10 | 187 | 91.2 | 77.4 |
| Embodiment 10 | 0.19 | 185 | 92.8 | 78.6 |
| Embodiment 11 | 0.25 | 180 | 92.7 | 78.6 |
| Embodiment 12 | 0.30 | 175 | 93.1 | 78.9 |
| Comparison | 0 | 205 | 82.2 | 47.1 |
| Example 6 | | | | |
| Comparison | 0.35 | 170 | 93.5 | 79.2 |
| Example 7 | | | | |
| Comparison | 0.5 | 153 | 94.1 | 80.8 |
| Example 8 | | | | |
| Comparison | 1 | 145 | 95.4 | 82.0 |
| Example 9 | | | | |

### Effects of the Ratio of the Volume of Secondary Granules to the Volume of Crystalline Granules (Embodiments 12 through 15 and Comparison Examples 10 through 12)

The fabrication method for said compounds of lithium nickel cobalt metal oxide remains the same as Embodiment 4 in this set of Embodiments and Comparison Examples. After fabrication, part of said fabricated compound is sifted and secondary granules that are larger than 8 μm are collected and labeled as A. Another part of said fabricated compound is grounded with a grinder until all secondary granules are broken into crystalline granules. This material is labeled as B.

Materials A and B are mixed in the ratios listed in Table 3. For the different ratios of A/B, the positive electrodes and batteries are fabricated in this same manner as described above. Table 3 lists the physical properties of the Embodiments and Comparison Examples and the battery characteristics of batteries with positive electrodes made from the Embodiments and Comparison Examples for the different ratios of A/B.

| | | | | Ini- | | |
|---|---|---|---|---|---|---|
| | | | | tial | | |
| | | | | Dis- | 100 | |
| | | | | charge | Cycle | |
| | | | | Spe- | Capa- | Large |
| | | | Tap | cific | city | current |
| Table 3 | | | Den- | Capa | Reten- | Discharge |
| Embodi- | A:B | | sity | city | tion | Charac- |
| ment | (Volume | | (g/ | (mAh/ | Rate | teristics |
| Number | Ration) | D₁₀μm | cm3) | g) | (%) | (%) |
| Embo- | 100:0 | 8.2 | 2.57 | 185 | 92.6 | 78.2 |
| diment 13 | | | | | | |
| Embo- | 95:5 | 8.0 | 2.54 | 186 | 92.9 | 78.8 |
| diment 14 | | | | | | |
| Embo- | 90:10 | 6.4 | 2.52 | 185 | 92.8 | 78.6 |
| diment 15 | | | | | | |
| Compar- | 85:15 | 3.4 | 2.29 | 172 | 93.0 | 74.3 |
| ison | | | | | | |
| Example | | | | | | |
| 10 | | | | | | |
| Compar- | 50:50 | 1.2 | 1.85 | 165 | 93.5 | 56.1 |
| ison | | | | | | |
| Example | | | | | | |
| 11 | | | | | | |
| Compar- | 0:100 | 0.5 | 1.60 | 157 | 93.6 | 53.7 |
| ison | | | | | | |
| Example | | | | | | |
| 12 | | | | | | |

Table 3 shows that, when D₁₀ is greater than 6 μm, i.e., when the volume of the crystalline granules that did not form the secondary granules is less then 10%, the battery exhibit good electrical properties.

### The Shape of the Compounds Lithium Nickel Cobalt Metal Oxide (Embodiments and Comparison Examples 13)

The fabrication method in Comparison Example 13 is the same as Embodiment 4 except that the cobalt nickel hydroxy compound Ni_{0.81}Co_{0.19}(OH)₂ in said fabrication has uneven shapes and is between 8 μm and 10 μm. The compound of lithium nickel cobalt metal oxide that is fabricated is examined with a scanning electron microscope and its tap density measured. A battery is made using the fabricated compound of Comparison 13 as the material for the positive electrode in the same manner as described above. The battery characteristics are tested and shown in Table 4.

| | | | Initial | |
|---|---|---|---|---|
| | | | Discharge | Large current |
| Table 4 | Shape of | | Specific | Discharge |
| Embodiment | Secondary | Tap Density | Capacity | Characteristics |
| Number | Balls | (g/cm3) | (mAh/g) | (%) |
| Embodiment 4 | Spherical | 2.51 | 185 | 78.6 |
| Comparison 13 | Plate | 2.09 | 178 | 60.4 |
| | Shaped, | | | |
| | Tetrahedron | | | |
| | Shaped; etc. | | | |
| | Uneven | | | |
| | Shaped | | | |

The above Embodiments and Comparison Examples show that the compounds of lithium nickel cobalt metal oxide, fabricated by the embodiments of the method of this invention, contain secondary granules formed by the aggregation of crystalline granules. These secondary granules are spherical or elliptical shaped and increase the tap density of the said compound of lithium nickel cobalt metal oxide. Rechargeable batteries using said compound as the material for the positive electrode material have higher discharge capacity, better charge and discharge cycle characteristics and large current discharge characteristics.

### Halite Magnetic Domain Formation (Embodiments 16 through 18 and Comparison Examples 14 through 16)

The following set of Embodiments and Comparison Examples examine the halite magnetic domain formation of said compounds of lithium nickel cobalt metal oxides.

### Embodiment 16

To fabricate this embodiment, ballgrind to mix the cobalt nickel hydroxy compound, Ni_{0.81}Co_{0.19}(OH)₂, with granule diameter between 8 μm and 10 μm and 5.2 times molar equivalent of lithium carbonate. The mixture is spread into a 2 cm thin layer, calcined first at 650° C. in oxygen atmosphere for 6 hours, and then calcined again at 800° C. for 16 hours to fabricate the LiNi_{0.81}Co_{0.19}O₂ positive electrode material.

### Embodiment 17

This embodiment uses the mixture of cobalt nickel hydroxy compound Ni_{0.81}Co_{0.19}(OH)₂, manganese dioxide and lithium carbonate in the molar ratio of 0.95:0.05:0.52 to fabricate the LiNi_{0.77}Co₀₁₈Mn_{0.05}O₂ positive electrode material. All other fabrication methods and conditions remain the same as Embodiment 16.

### Embodiment 18

This embodiment uses the mixture of Ni_{0.81}Co_{0.19}(OH)₂, aluminum hydroxide and lithium carbonate in the molar ratio of 0.95:0.05:0.52 to fabricate the LiNi_{0.77}Co_{0.18}Al_{0.05}O₂ positive electrode material. All other fabrication methods and conditions remain the same as Embodiment 16.

### Comparison Example 14

This Comparison Example uses the same ingredient and fabrication method as Embodiment 16 except that the calcination processes are in air.

### Comparison Example 15

The fabrication method is the same as Embodiment 16 except that this comparison example uses a mixture of nickel hydroxide, tri-cobalt tetra-oxide and lithium carbonate in the molar ratio of 0.81:0.06:0.52.

### Comparison Example 16

To fabricate this Comparison Example, mix nickel hydroxide with granule diameter between 8 μm and 10 μm and lithium carbonate in the molar ratio of 1:0.52. The mixture is calcined at 750° C. in air for 6 hours to obtain LiNiO₂.

To examine the formation of halite magnetic domains, a Japanese Science Company (Rigaku) product, model number D/MAX 2200PC, style XRD, is used to obtain the X-ray diffraction picture (CuKα) on the compounds of lithium nickel cobalt metal oxide of the above Embodiments and Comparison Examples. Cu is used as the target. The voltage is set at 40 kV and the current is set at 20 mA. In Embodiments 16 through 18, the ratio of the intensity of the diffraction peak on the (003) crystalline surface, I₀₀₃, to the intensity of the diffraction peak on the (104) crystalline surface, I₁₀₄, I₀₀₃/I₁₀₄, is >1.20 thus allowing the conclusion that the materials basically do not have the “halite magnetic domain” formation. In Comparison Examples 14 through 16, the ratio of the intensity of the diffraction peak on the (003) crystalline surface, I₀₀₃, to the intensity of the diffraction peak on the (104) crystalline surface, I₁₀₄, I₀₀₃/I₁₀₄, is<1.20 thus allowing the conclusion that the materials have the “halite magnetic domain” formation.

To test the electrochemical properties for each of the above Embodiments and Comparison Examples, batteries are fabricated with positive electrodes using each of said Embodiments and Comparison Examples.

The material for a positive electrode is fabricated by mixing together 90% by weight the compound of lithium nickel cobalt metal oxide from said Embodiment or Comparison Example, 4% by weight of acetylene black, and 4% by weight polyvinylidene fluorine. N-methyl pyrrolidone is used as the dispersant. The mixture is heated dry at 150° C. in vacuum to completely evaporate the N-methyl pyrrolidone to obtain the material for the positive electrode.

To make the positive electrode, said fabricated material is pressed together with a circular lithium net and heat at between 170° C. and 180° C. in vacuum for 4 hours.

To make the battery with above described fabricated positive electrode, a circular lithium metal slice is used as the negative electrode, and a mixture ethyl carbonate and dimethyl carbonate containing 1 m of LiPF₆ as the electrolyte material.

To test the cycle characteristics of the fabricated battery, the battery is charged and discharged at 1 mA/cm². The results of the test are shown in Table 5

TABLE 5
The Structure and Electrochemical Properties
of Different Positive Electrode Material

| | | | | Specific |
|---|---|---|---|---|
| | | | Initial | Discharge |
| | Materials | | Discharge | Capacity |
| | for the | | Specific | after 100 |
| | Positive | | Capcity/ | cycles/ |
| Experiments | Electrode | I0₀₃/I₁₀₄ | mAh/g | mAh/g |
| Embodiment | LiNi_{0.81}Co_{0.19}O₂ | 1.37 | 180 | 166 |
| 1 | | | | |
| Embodiment | LiNi_{0.77}Co_{0.18}Mn0_{.05}O₂ | 1.33 | 176 | 168 |
| 2 | | | | |
| Embodiment | LiNi_{0.77}Co_{0.18}Al_{0.05}O₂ | 1.34 | 175 | 167 |
| 3 | | | | |
| Comparison | LiNi_{0.81}Co_{0.19}O₂ | 1.11 | 174 | 133 |
| Example 1 | | | | |
| Comparison | LiNi_{0.81}Co_{0.19}O₂ | 1.15 | 175 | 145 |
| Example 2 | | | | |
| Comparison | LiNiO₂ | 0.91 | 174 | 88 |
| Example 3 | | | | |

Table 5 shows that the LiₐNi_{1-b-c}Co_{b}M_{c}O₂ compounds fabricated by the Embodiments of this invention is superior to similar materials fabricated using convention methods, both in the structure of the compounds and their electrochemical properties. Said compounds exhibit superior energy density and excellent charge and discharge cycle characteristics. They have a high economic value since they are cheaper to manufacture due to their much lower Co content than the LiCoO₂ compounds now commonly used as the material for positive electrode material.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We claim:

1. A compound of lithium nickel cobalt metal oxide having a formula, LiaNi1-b-cCobMcO₂;
wherein 0.97≦a≦1.05, 0.01≦b≦0.30, 0≦c≦0.10;
wherein M is at least one metal selected from the group consisting of: manganese, aluminum, titanium, chromium, magnesium, calcium, vanadium, iron, and zirconium;
wherein said compound of lithium nickel cobalt metal oxide having a first (003) crystalline surface having a X-ray diffraction peak with an intensity of I₀₀₃;
wherein said compound of lithium nickel cobalt metal oxide having a second (104) crystalline surface having an X-Ray diffraction peak with an intensity of I₁₀₄; and
wherein the ratio of said I₀₀₃/I₁₀₄ is larger than 1.02.

2. The compound of lithium nickel cobalt metal oxide of claim 1, further comprising:
crystalline granules having granule diameters between 0.5 μm and 4 μm;
secondary granules having granule diameters between 10 μm and 40 μm; and
wherein the volume of said small crystalline granules is less then 10% of the volume of said compound of lithium nickel cobalt metal oxide.

3. The compound of lithium nickel cobalt metal oxide of claim 2 wherein said secondary granules are formed by the aggregation of said crystalline granules during calcination.

4. The compound of lithium nickel cobalt metal oxide of claim 2 wherein said crystalline granules are either spherically or elliptically shaped and said secondary granules are either spherically or elliptically shaped.

5. A compound of lithium nickel cobalt metal oxide, comprising:
crystalline granules having granule diameters between 0.5 μm and 4 μm;
secondary granules having granule diameters between 10 μm and 40 μm;
wherein said secondary granules are formed by the aggregation of said crystalline granules during calcination;
wherein said crystalline granules are either spherically or elliptically shaped;
wherein said secondary granules are either spherically or elliptically shaped;
wherein the volume of said small crystalline granules is less then 10% of the volume of said compound of lithium nickel cobalt metal oxide;
wherein said compound of lithium nickel cobalt having a formula LiaNi1-b-c-CobMcO₂;
wherein 0.97≦a≦1.05, 0.01≦b≦0.30, 0≦c≦0.10;
wherein M is at least one metal selected from the group consisting of: manganese, aluminum, titanium, chromium, magnesium, calcium, vanadium, iron, and zirconium;
wherein said compound of lithium nickel cobalt metal oxide having a first (003) crystalline surface having a X-ray diffraction peak with an intensity of I₀₀₃;
wherein said compound of lithium nickel cobalt metal oxide having a second (104) crystalline surface having an X-Ray diffraction peak with an intensity of I₁₀₄; and
wherein the ratio of said I₀₀₃/I₁₀₄ is larger than 1.02.

6. The compound of lithium nickel cobalt metal oxide of claim 1, wherein a method for fabricating said compound of lithium nickel cobalt metal oxide comprising the steps of:
forming a cobalt nickel hydroxy compound having a chemical formula of Ni_{1-b}Co_{b}(OH)₂;
ballgrinding to evenly mix a lithium compound, a compound of said metal M, and said cobalt nickel hydroxy compound;
calcining said mixture in a first oxygen atmosphere at between 600° C. and 720° C. for 1 hour to 10 hours to obtained a first calcined compound;
calcining said first calcined compound in a second oxygen atmosphere at between 750° C. and 900° C. for 8 hours to 20 hours to obtain a second calcined compound;
cooling said second calcined compound;
ballgrinding said cooled second calcined compound to obtain ballgrinded compound; and
sifting said ballgrinded compound to obtain said compound of lithium nickel cobalt metal oxide.

7. The fabrication method of claim 6 wherein said cobalt nickel hydroxy compound is spherically or elliptically shaped.

8. The fabrication method of claim 6, wherein said cobalt nickel hydroxy compound having D₅₀ granule diameter, D₁₀ granule diameter and D₉₀ granule diameter;
wherein said D₅₀ granule diameter≧8 μm;
wherein said D₁₀ granule diameter≧4 μm; and
wherein said D₉₀ granule diameter≦30 μm.

9. The fabrication method of claim 8, wherein said cobalt nickel hydroxy compound is spherically or elliptically shaped.

10. The fabrication method of claim 6, wherein the method for forming said cobalt nickel hydroxy compound comprises the following steps:
mixing uniformly cobalt sulfate and nickel sulfate to form a first solution; and
adding ammonia to form a reaction solution wherein said first solution and ammonia react to form said cobalt nickel hydroxy compound.

11. The fabrication method of claim 10,
wherein said nickel sulfate having a concentration of between 1.5 mole/liter and 2 mole/liter;
wherein cobalt sulfate having a concentration of between 0.3 mole/liter and 0.5 mole/liter;
wherein said ammonia having a concentration of between 10 mole/liter and 14 mole/liter;
wherein said reaction solution having a temperature of between 40° C. and 60° C.;
wherein said reaction solution having a pH of between 11 and 12; and
wherein said first solution and ammonia react for between 9 hours and 12 hours to form said cobalt nickel hydroxy compound.

12. The fabrication method of claim 10, wherein said cobalt nickel hydroxy compound having D₅₀ granule diameter, D₁₀ granule diameter and D₉₀ granule diameter;
wherein said D₅₀ granule diameter≧8 μm;
wherein said D₁₀ granule diameter≧4 μm; and
wherein said D₉₀ granule diameter≦30 μm.

13. The fabrication method of claim 10, wherein said cobalt nickel hydroxy compound is spherically or elliptically shaped.

14. The fabrication method of claim 11,
wherein said cobalt nickel hydroxy compound having D₅₀ granule diameter, D₁₀ granule diameter and D₉₀ granule diameter;
wherein said D₅₀ granule diameter≧8 μm;
wherein said D₁₀ granule diameter≧4 μm;
wherein said D₉₀ granule diameter≦30 μm; and
wherein said cobalt nickel hydroxy compound is spherically or elliptically shaped.

15. The fabrication method of claim 6 wherein said first oxygen atmosphere and said second oxygen atmosphere are between 0.08 MPa and 0.1 MPa.

16. The fabrication method of claim 6 wherein the ratio of the molar content of Li/(Li+Co+M) is between 1.01 and 1.10.

17. The fabrication method of claim 6 wherein said mixture having a thickness≦5 cm. and said first calcined compound having a thickness≦5 cm.

18. The fabrication method of claim 6 wherein in said cooling step, the second calcined compound is cooled rapidly in dry air.

19. The fabrication method of claim 15,
wherein the ratio of the molar content of Li/(Li+Co+M) is between 1.01 and 1.10;
wherein said mixture having a thickness≦5 cm. and said first calcined compound having a thickness≦5 cm; and
wherein in said cooling step, the second calcined compound is cooled rapidly in dry air.

20. The fabrication method of claim 11,
wherein said first oxygen atmosphere and said second oxygen atmosphere are between 0.08 MPa and 0.1 Mpa;
wherein the ratio of the molar content of Li/(Li+Co+M) is between 1.01 and 1.10;
wherein said mixture having a thickness≦5 cm. and said first calcined compound having a thickness≦5 cm; and
wherein in said cooling step, the second calcined compound is cooled rapidly in dry air.
